(19) United States
(12) Patent Application Publication
(10) Pub. No.: US 2016/0053101 A1
(43) Pub. Date: Feb. 25, 2016

(54) PHOTONIC CRYSTALS

(71) Applicant: SOLVAY SPECIALTY POLYMERS ITALY S.P.A., Bollate (Milano) (IT)

(72) Inventors: Stefano Vincenzo RADICE, Meda (IT); Piero GAVEZOTTI, Milano (IT); Giovanni SIMEONE, Solaro (IT); Margherita ALBANO, Milano (IT); Simone CONGIU, Genova (IT); Giancarlo CANAZZA, Genova (IT); Davide COMORETTO, Milano (IT)

(21) Appl. No.: 14/779,459

(22) PCT Filed: Mar. 20, 2014
(86) PCT No.: PCT/EP2014/055590

§ 371 Date: Sep. 23, 2015

(30) Foreign Application Priority Data
Mar. 26, 2013 (EP) 13161078.4

(51) Int. Cl. C08L 25/06; C08G 65/00; C08L 37/00; C08L 71/00; C08L 27/18

(52) U.S. Cl. CPC C08L 25/06; C08L 71/00; C08L 27/18; C08L 37/00; C08G 65/00; C08L 2205/18

(57) ABSTRACT

Two- or three-dimensional photonic crystals comprising at least of fluorinated polymer are disclosed. The two- or three-dimensional photonic crystals have infiltrated opal or inverse opal structures.

This application claims priority to European application No. 13161078.4 filed on Mar. 26, 2013, the whole content of this application being incorporated herein by reference for all purposes.

### TECHNICAL FIELD

The present invention relates to two- or three-dimensional photonic crystals and to methods of making two- or three-dimensional photonic crystals. More specifically, the present invention relates to two- or three-dimensional photonic crystals comprising a fluorinated polymer.

### BACKGROUND ART

Artificial photonic crystals, owing to their potential technological applications, have earned a significant interest in the field of optics, see for instance LOPEZ, C. Materials Aspects of Photonic Crystals. Advanced Materials. 2003, vol. 15, no. 20, p. 1679-1704. Photonic crystals are expected to be used in a variety of applications including optical filters, sharp bending light guides, very low threshold lasers, solar cells, optical limiters/switches, colour displays, spectrally tuned dielectric mirrors, chromatic pressure sensors, and sensor devices, and have been investigated widely.

WO 00/21905 A (ALLIED SIGNAL INC [US]) discloses processes for manufacturing three-dimensional periodical arrays of three dimensional structures that are used for a variety applications. In particular, the process comprises:
(a) crystallizing spheres of material A into a first structure having three-dimensional periodicity, and voids between the spheres, wherein the material A is mechanically and thermally stable to at least 300° C.,
(b) treating this first structure so that necks are formed between the spheres of material A,
(c) infiltrating said first structure with material B to form an A-B composite structure, and
(d) removing material A from said A-B composite structure to form a second structure comprising material B.

As material B, this document exemplifies block copolymers, preferably “diblock and triblock polymers involving linkages of either polystyrene, polybutadiene, polyisoprene, poly(methacrylate), poly(propyleneoxide), poly(dimethylsiloxane), or polyethylene oxide” (page 22, lines 12-14).

Thus, this document teaches to prepare a composite structure of a material A, to infiltrate that structure with a material B and then to remove structure A to obtain a structure made with material B only.

For the purposes of optical applications, this document lists a series of infiltrated materials having a refractive index that is above 1.35.

US 2003185532 (HOSOMI KAZUHIKO ET AL.) discloses an optical functional device which comprises two or more materials that are periodically structurally arrayed in a bi-dimensional structure, wherein at least one of the two materials is a polymer, like a fluorinated polyimide. This document further teaches that the temperature that the at least one polymer is changed to thereby control the refractive index of the photonic crystal.

US 2007269178 (ASAHI GLASS CO LTD [JP]) discloses an optical waveguide made of a fluorinated amorphous polymer. The waveguide may have a photonic crystal structure and the polymer can be made by copolymerization of a monomer having a fluorinated ring structure and tetrafluoroethylene. In the description of the preferred embodiment, it is explained that the optical waveguide can be manufactured by casting a polymer solution into a cast mold to obtain plates and then by subjecting the plates to drilling to obtain holes.

US 2011250453 (BASF SE [DE]) discloses the use of polymer particles for making photonic crystals and a method for the manufacture of the crystals by contacting an aqueous polymer dispersion of the polymer with a suitable support and then removing the water by evaporation.

It has now been found that two- or three-dimensional photonic crystals with good optical properties can be conveniently prepared using certain fluorinated polymers. In particular, it has been found that, by using as infiltrated materials certain fluorinated polymers having a lower refractive index than that of the polymers disclosed in WO 00/21905 A (ALLIED SIGNAL INC [US]) for optical applications, optical performances improve and the manufacturing process of the crystals is more convenient to be carried out on an industrial scale, even at room temperature.

### BRIEF DESCRIPTION OF DRAWINGS

FIG. 1 shows the reflectance spectra of 300 nm polystyrene opals before and after infiltration with Fluorolink® MD500 PFPE (dashed line=bare opal; full line=infiltrated opal).

FIG. 2 shows the reflectance spectrum of 426 nm polystyrene opals before and after infiltration with Fluorolink® MD500 PFPE (dashed line=bare opal; full line=infiltrated opal).

### SUMMARY OF INVENTION

In one aspect of the invention there is provided a two- or three-dimensional photonic crystal comprising at least a first dielectric component comprising at least one fluorinated polymer said first dielectric component having a refractive index n₁; and at least a second component having a refractive index n₂ different from n₁.

In an advantageous aspect of the invention there is provided a three-dimensional photonic crystal having a so-called opal structure, that is comprising a plurality of close packed monodisperse spheres comprising a component having refractive index n₂ in a matrix comprising the first dielectric component having a refractive index n₁.

In another aspect of the invention there is provided a three-dimensional photonic crystal having a so-called inverse opal structure comprising a plurality of close packed monodisperse spherical air voids in a matrix comprising the first dielectric component comprising a fluorinated polymer.

In another aspect of the invention there is provided a method of making a two- or three-dimensional photonic crystal.

In still another aspect of the invention there is provided a device comprising the two- or three-dimensional photonic crystal of the invention.

### DESCRIPTION OF INVENTION

A first object of the present invention is a two- or three-dimensional photonic crystal comprising at least a first dielectric component comprising at least one fluorinated polymer, said first dielectric component having a refractive index n₁; and at least a second component having a refractive index n₂ different from n₁.

The expression “photonic crystal” is used herein in its conventional meaning to refer to optical structures having a periodic arrangement of materials with different refractive indices. Photonic crystals are generally defined as materials with a spatial periodicity in their refractive index.

Photonic crystals are composed of periodic dielectric nanostructures that affect the propagation of electromagnetic waves and the radiative recombination processes such as the spontaneous/stimulated emission and related phenomena. Photonic crystals contain regularly repeating regions of high and low refractive index. Photons propagate through this structure, or not, depending on their wavelength. Wavelengths that are allowed to travel are known as modes; groups of allowed modes form bands. Disallowed bands of wavelengths are called photonic “stop-bands”.

In a two-dimensional photonic crystal the periodic variation of the refractive index takes place along two directions, typically two orthogonal axes.

In a three-dimensional photonic crystal the periodic variation of the refractive index takes place along three directions, typically the three orthogonal axes.

The photonic crystal of the present invention comprises at least two components having different refractive indexes n₁ and n₂.

The First Dielectric Component

The first dielectric component comprises at least one fluorinated polymer.

The at least one fluorinated polymer is generally characterised by a bulk refractive index n_{FP} of at least 1.200, more typically of at least 1.250. The fluorinated polymer generally has a bulk refractive index n_{FP} not exceeding 1.440, more typically not exceeding 1.400. According to a preferred embodiment, bulk refractive index n_{FP} does not exceed 1.350 and preferably ranges from 1.250 to 1.350. The expression “bulk refractive index” is used herein to refer to the refractive index of a sample consisting of the fluorinated polymer.

Typically the first dielectric component comprises at least 50 wt %, preferably at least 60 wt %, more preferably at least 75 wt %, and even more preferably at least 85 wt % of the at least one fluorinated polymer. Advantageously, the first dielectric component comprises more than 90 wt % and even more than 95 wt % of the at least one fluorinated polymer. The first dielectric component may even consist of the at least one fluorinated polymer.

Additional ingredients might possibly be present in the first dielectric component. Among possible additional ingredients for the first dielectric component mention may be made of viscosity modifiers, solvents, emulsifiers, organic and inorganic fluorophores, phosphorescence and chemiluminescent materials, Non Linear Optical Materials, charge transport dopants, chemical receptors, and the like.

The expression “at least one” when referred to the fluorinated polymer of the first dielectric component indicates that one or more than one fluorinated polymer may be present. Preferably the first dielectric component comprises only one fluorinated polymer.

When the first dielectric component consists of one fluorinated polymer, refractive index n₁ will correspond to the bulk refractive index n_{FP} of the fluorinated polymer.

When the first dielectric component comprises more than one fluorinated polymer or it comprises additional ingredients then the effective refractive index n₁ of the first dielectric component may be calculated according to the suitable effective medium approximation as discussed in GHER, R. J., et al. Optical properties of nanostructured optical materials. Chem. Mater.. 1996, vol. 8, p. 1807-1819.

The first dielectric component may comprise any type of fluorinated polymer provided it has suitable optical properties. The expression “fluorinated polymer” is used herein to refer to any polymer comprising recurring units comprising fluorine atoms.

A first class of suitable fluorinated polymers for use in the first dielectric component are those selected from the group consisting of fluorinated polymers comprising alicyclic structures in the polymer main chain.

Fluorinated polymers comprising alicyclic structures in the polymer main chain are known in the art. They have been described for instance in EP 803557 A (SOLVAY SOLEXIS SPA) 29.10.1997, in EP 1256591 A (SOLVAY SOLEXIS SPA) 13.11.2002, in EP 645406 A (DU PONT DE NEMOURS) 29.03.1995 and in EP 303298 A (ASAHI GLASS COMPANY) 15.02.1989 .

Non limiting examples of fluorinated polymers comprising alicyclic structures in the polymer main chain are those comprising recurring units derived from at least one fluorinated monomer selected from the group consisting of:
the fluorodioxoles of formula (I):

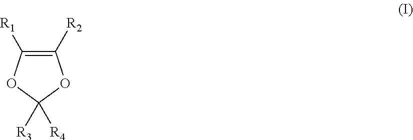

wherein R₁, R₂, R₃ and R₄, equal to or different from each other, are independently selected from the group consisting of —F, a C₁-C₆ fluoroalkyl, optionally comprising one or more oxygen atoms, a C₁-C₆ fluoroalkoxy, optionally comprising one or more oxygen atoms;
the fluorodioxolanes of formula (II):

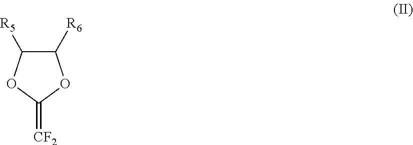

wherein R₅ and R₆, equal to or different from each other, are independently selected from the group consisting of —F, a C₁-C₆ fluoroalkyl, optionally comprising one or more oxygen atoms, a C₁-C₆ fluoroalkoxy, optionally comprising one or more oxygen atoms; and
the cyclopolymerizable monomers of formula (III):

CR₇R₈═CR₉OCR₁₀R₁₁(CR₁₂R₁₃)ₐ(O)_{b}CR₁₄═CR₁₅R₁₆ (III)

wherein each R₇ to R₁₆, independently of one another, is selected from —F, and a C₁-C₃ fluoroalkyl, a is 0 or 1, b is 0 or 1 with the proviso that b is 0 when a is 1.

Preferably the fluorinated polymers comprising alicyclic structures in the polymer main chain suitable for the first dielectric component are those selected from the group consisting of:
the copolymers of tetrafluoroethylene and the fluorodioxoles of formula (I) as defined above wherein R₁, R₂, R₃ and R₄, equal to or different from each other, are independently selected from the group consisting of —F, a C₁-0₆ fluoroalkyl, optionally comprising one or more oxygen atoms, a C₁-C₆ fluoroalkoxy, optionally comprising one or more oxygen atoms; preferably wherein R₁, R₂, R₃ and R₄, equal to or different from each other, are independently selected from the group consisting of —F, a C₁-C₃ perfluoroalkyl, e.g. —CF₃, —C₂F₅, —C₃F₇, and a C₁-C₃ perfluoroalkoxy optionally comprising one oxygen atom, e.g. —OCF₃, —OC₂F₅, —OC₃F₇, —OCF₂CF₂OCF₃; more preferably wherein R₁═R₂═—F and R₃=R₄ is a C₁-C₃ perfluoroalkyl, preferably R₃═R₄═—CF₃ or wherein R₁═R₃═R₄═—F and R₂ is a C₁-C₃ perfluoroalkoxy, e.g. —OCF₃, —OC₂F₅, —OC₃F₇; and
the polymers comprising recurring units derived from the cyclopolymerizable monomers of formula (III) as defined above, wherein each R₇ to R₁₆, independently of one another, is selected from —F, and a C₁-C₃ fluoroalkyl, a is 0 or 1, b is 0 or 1 with the proviso that b is 0 when a is 1; preferably in formula (III) each R₇ to R₁₆ is —F; more preferably in formula (III) each R₇ to R₁₆ is —F, a=1 and b=0.

More preferably the fluorinated polymers comprising alicyclic structures in the polymer main chain for the first dielectric component are those selected from the group consisting of:
the copolymers of tetrafluoroethylene and the fluorodioxoles of formula (I) as defined above wherein R₁═R₃═R₄═—F and R₂═—OCF₃ or wherein R₁═R₂═—F and R₃═R₄═—CF₃; and
the polymers comprising recurring units derived from the cyclopolymerizable monomers of formula (III) as defined above, wherein each R₇ to R₁₆ is —F, a=1 and b=0.

Even more preferably the fluorinated polymers comprising alicyclic structures in the polymer main chain for the first dielectric component are those selected from the group consisting of:
the amorphous copolymers of tetrafluoroethylene and the fluorodioxoles of formula (I) as defined above wherein R₁=R₃═R₄═—F and R₂═—OCF₃ or wherein R₁═R₂═—F and R₃═R₄═—CF₃; and
the amorphous polymers comprising recurring units derived from the cyclopolymerizable monomers of formula (III) as defined above, wherein each R₇ to R₁₆ is —F, a=1 and b=0.

The term “amorphous” is used herein to refer to a material having no crystallinity. For the purposes of the present invention an amorphous material is intended to be a material characterized by a heat of fusion lower than 5 J/g as determined by differential scanning calorimetry (DSC) according to ASTM D3418-08.

Amorphous fluorinated polymers comprising recurring units derived from fluorodioxoles of formula (I) suitable for the photonic crystal of the invention are commercially available under the trade name HYFLON® AD (Solvay Specialty Polymers Italy SpA) and TEFLON® AF (Du Pont), whereas amorphous fluorinated polymers comprising recurring units derived from cyclopolymerizable monomers of formula (III) are commercially available under the trade name CYTOP® (Asahi Glass Company).

Amorphous fluorinated polymers comprising recurring units derived from fluorodioxoles of formula (I) or from monomers of formula (III) typically have a bulk refractive index n_{FP} of from 1.298 to 1.334, i.e. within the preferred range 1.250 to 1.350.

A second class of suitable fluorinated polymers for use in the first dielectric component are those selected from the group consisting of elastomers comprising fluoropolyether chains.

Notable, non limiting examples of suitable elastomers comprising fluoropolyether chains can be found in WO 2010/094661 (SOLVAY SOLEXIS SPA) 26.08.2010 which discloses elastomers obtained by the UV-curing of compositions comprising: at least one functional fluoropolyether compound comprising a fluoropolyoxyalkylene chain (R_{f}) and having at least two unsaturated moieties; and at least one photoinitiator.

The functional fluoropolyether compound may be selected among those compounds of formula (IV):

T₁—J—R_{f}—J′—T₂ (IV)

wherein
R_{f} represents a fluoropolyoxyalkylene chain comprising recurring units having general formula: —(CF₂)ₖ—CFZ—O—, wherein k is an integer of from 0 to 3 and Z is selected between a fluorine atom and a C₁-C₅ perfluoroalkyl group, optionally comprising one or more oxygen atom; preferably chain R_{f} complies with formula: —(CF₂O)ₚ(CF₂CF₂O)_{q}(CFYO)ᵣ(CF₂CFYO)ₛ—(CF₂(CF₂)_{z}CF₂O)ₜ—
wherein Y is a C₁-C₅ perfluoroalkyl group, optionally comprising one or more oxygen atom, z is 1 or 2; and p, q, r, s, t are integers ÷0; chain R_{f} more preferably complies with formula: —(CF₂O)ₚ′(CF₂CF₂O)_{q}′— wherein p′ and q′ are integers ≧0; said chain R_{f} typically has an average molecular weight of more than 1000 and less than 3500;
J and J′, equal to or different from each other, are independently a bond or a divalent bridging group, and
T₁ and T₂, equal to or different from each other, are selected from the group consisting of:
(A) —O—CO—CR_{H}═CH₂,
(B) —O—CO—NH—CO—CR_{H}═CH₂,
(C) —O—CO—R^{A}—CR_{H}═CH₂,
wherein R_{H} is H or a C₁-C₆ alkyl group; R^{A} is selected from the group consisting of:
(j) —NH—R^{B}—O—CO—
(jj) —NH—R^{B}—NHCOO—R^{B}—OCO—;
R^{B} being a divalent group selected from the group consisting of C₁-C₁₀ aliphatic group, C₅-C₁₄ cycloaliphatic group; C₆-C₁₄ aromatic or alkylaromatic group.

In formula (IV) chain R_{f} has preferably an average molecular weight between 1000 and 3000, more preferably between 1100 and 3000, even more preferably between 1100 and 2500; it is thus understood that in corresponding preferred structures as above detailed p, q, r, s, t, p′ and q′ represent integers selected so as to comply with these molecular weight requirements.

Non-limiting examples of suitable compounds of formula (IV) are those selected from the group consisting of:

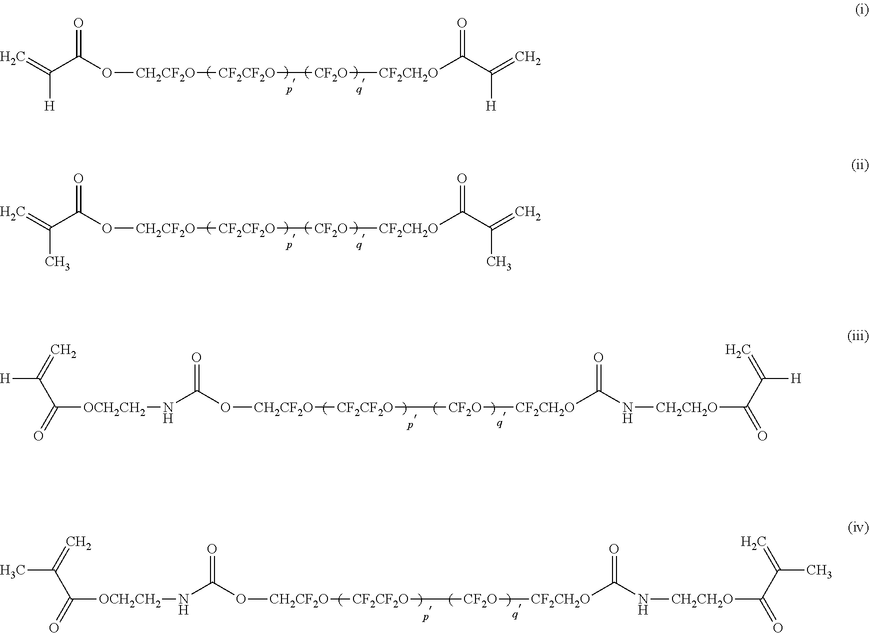

wherein in formulae (i) to (iv) p′ and q′ are selected so that the average molecular weight of chain R_{f} is preferably comprised between 1000 and 3500.

Compositions suitable for the preparation of elastomeric polymers by UV curing are commercially available from Solvay Specialty Polymers Italy SpA under the trade name Fluorolink®, e.g. Fluorolink® MD500 PFPE.

According to a preferred embodiment, the elastomeric polymers obtainable by UV curing of a functional fluoropolyether compound of formula (IV) are those having a bulk refractive index n_{FP} of from 1.250 to 1.350.

A third class of suitable fluorinated polymers for use in the first dielectric component are those selected from the group consisting of fluoroelastomers. Typically fluoroelastomers are amorphous polymers and have a glass transition temperature (T_{g}) below room temperature, in most cases even below 0° C.

Suitable fluoroelastomers advantageously comprise recurring units derived from vinylidene fluoride and/or from tetrafluoroethylene.

Preferably, the fluoroelastomer used as the first dielectric component in the photonic crystal of the invention consists of recurring units derived from vinylidene fluoride and/or from tetrafluoroethylene and at least one other fluorinated monomer. In particular suitable fluorinated monomers are selected from:
fluoroalkylvinylethers of formula CF₂═CFOR₁₇, wherein R₁₇ is a C₁-C₆ fluoroalkyl, e.g. —CF₃, —C₂F₅, —C₃F₇;
fluoro-oxyalkylvinylethers of formula CFX═CX₁OR₁₈, wherein X and X1 are each independently selected from —H and —F and R₁₈ is a C₁-C₁₂ perfluorooxyalkyl, containing one or more ether groups, for example perfluoro-2-propoxy-propyl; in particular compounds having general formula: CFX═CX₁OCF₂OR₁₉ wherein R₁₉ is selected from C₂-C₆ linear or branched fluoroalkyl, C₅-C₆ cyclic fluoroalkyl, C₂-C₆ linear or branched fluorooxyalkyl containing from one to three oxygen atoms, preferably selected from the following: CF₂═CFOCF₂OCF₂CF₃, CF₂═CFOCF₂OCF₂CF₂OCF₃, CF₂═CFOCF₂OCF₃.

The fluoroelastomer can optionally contain recurring units deriving from C₃-C₈ fluoroolefins, optionally containing hydrogen atoms, chlorine and/or bromine and/or iodine, C₂-C₈ non-fluorinated olefins, preferably ethylene and/or propylene.

Suitable fluoroelastomers for use in the first dielectric component are for instance those described in U.S. Pat. No. 5,585,449 (AUSIMONT SPA) 17.12.1996 , U.S. Pat. No. 5,264,509 (AUSIMONT SPA) 23.11.1993 , EP 683149 A (AUSIMONT SPA) 22.11.1996 or in EP 1626068 A (SOLVAY SOLEXIS SPA) 15.02.2006 .

The fluoroelastomer can optionally contain from 0.01 to 1.00 mol % of recurring units deriving from bis-olefins as described in U.S. Pat. No. 5,585,449 (AUSIMONT SPA) 17.12.1993 .

Notable non-limiting examples of suitable fluoroelastomers are for instance copolymers of vinylidene fluoride, hexafluoropropene, tetrafluoroethylene and perfluoroalkyl vinyl ethers; copolymers of vinylidene fluoride, hexafluoropropene and optionally tetrafluoroethylene; copolymers of vinylidene fluoride, perfluoroalkyl vinyl ether, and optionally tetrafluoroethylene; copolymers of vinylidene fluoride, C₂-C₈ non-fluorinated olefins, hexafluoropropylene and/or perfluoroalkyl vinyl ether and tetrafluoroethylene; copolymers comprising vinylidene fluoride and fluoromethoxyvinyl ether and optionally perfluoroalkyl vinyl ether and tetrafluoroethylene ; copolymers of tetrafluoroethylene and perfluoroalkyl vinyl ether.

Preferably the fluoroelastomers for the first dielectric component are those selected from the group consisting of: copolymers of vinylidene fluoride (55-85 mol %), hexafluoropropene (15-45 mol %) and optionally tetrafluoroethylene (0-30 mol %); copolymers of vinylidene fluoride (50-80 mol %), perfluoroalkyl vinyl ether (5-50 mol %), and optionally tetrafluoroethylene (0-20 mol %); copolymers of vinylidene fluoride (20-30 mol %), C₂-0₈ non-fluorinated olefins (10-30 mol %), hexafluoropropylene and/or perfluoroalkyl vinyl ether (18-27 mol %) and tetrafluoroethylene (10-30 mol %); copolymers comprising vinylidene fluoride (50-80 mol %) and fluoromethoxyvinyl ether (20-50 mol %) and optionally tetrafluoroethylene (0-20 mol %); copolymers of tetrafluoroethylene (50-80 mol %) and perfluoroalkyl vinyl ether (20-50 mol %); copolymers of tetrafluoroethylene (50-80 mol %) and perfluoromethoxyvinyl ether (20-50 mol %); copolymers of tetrafluoroethylene (45-65 mol %), C₂-C₈, non-fluorinated olefins (10-40 mol %), perfluoroalkyl vinyl ether or vinylidene fluoride (0-40 mol %); copolymers of tetrafluoroethylene (33-75 mol %), perfluoroalkyl vinyl ether (15-45 mol %) and vinylidene fluoride (10-22 mol %).

The bulk refractive index n_{FP} of fluoroelastomers described above is typically from 1.320 to 1.400.

Fluoroelastomers suitable for the photonic crystal of the invention are commercially available under the trade name TECNOFLON® (Solvay Specialty Polymers Italy SpA), TECNOFLON® PFR (Solvay Specialty Polymers Italy SpA), VITON® (Du Pont), KALREZ® (Du Pont), DAIEL® (Daikin), FLUOREL® (Dyneon, 3M).

A fourth class of suitable fluorinated polymers for use in the first dielectric component are those selected from the group consisting of fluorosilicone rubbers (FVMQ), for instance those described in PIERCE, O. R., et al. Fluorosilicone rubber. Industrial and Engineering Chemistry Research. 1960, vol. 52, p. 783-784. and in CORNELIUS, D. J., et al. The unique properties of silicone and fluorosilicone elastomers. Polym. & Eng. Science. 1985, vol. 25, p. 467-473.

Fluorosilicone rubbers typically contain recurring units of formula (V):

—(Si(CH₃)(R_{F})—O—)— (V)
wherein R_{F} is a C₁-C₆ fluoroalkyl, typically —CH₂CH₂CF₃.

Fluorosilicone rubbers suitable for the photonic crystal of the invention are commercially available under the trade name Silastic (Dow Corning), FQE®/FSE (Momentive Performance Materials), FE® (Shin-Etsu), ELASTOSIL® FLR (Wacker).

The fluorinated polymer for the first dielectric component is preferably selected from the groups consisting of the fluorinated polymers comprising alicyclic structures in the polymer main chain and the elastomers comprising fluoropolyether chains as defined above. More preferably, said fluorinated polymers are selected from those having a bulk refractive index n_{FP} that does not exceed 1.350 and that preferably ranges from 1.250 to 1.350. It has indeed been observed that the selection of such fluorinated polymers allows obtaining photonic crystals whose optical properties (for instance the bandgap spectral position and its bandwidth) can be tuned according to specific needs and which can be conveniently manufactured at room temperature on an industrial scale.

The Second Component

In addition to the first dielectric component which comprises a fluorinated polymer the photonic crystal of the invention comprises at least one second component. The second component is characterised by having a refractive index n₂ which is different from the refractive index n₁ of the first dielectric component.

There is no limitation on the nature of the second component.

Typically the difference, in absolute value, between refractive index n₁ of the first dielectric component and refractive index n₂ of the second component is of at least 0.001 units, preferably of at least 0.005 units.

In a first, preferred, embodiment of the photonic crystal of the invention the second component is a dielectric material, hereinafter referred to as the “second dielectric component”.

In a first aspect of said first embodiment the second dielectric component has a refractive index n₂ greater than n₁. Refractive index n₂ is at least 0.001 units greater than n₁, preferably at least 0.005 units greater than n₁. In general, the larger the difference, in absolute value, between n₁ and n₂ the larger the width of the photonic stop-band of the photonic crystal. Thus, the upper limit of the difference |n₂-n₁| will be determined by the final application of the photonic crystal.

The second dielectric component may be organic or inorganic. Among suitable organic materials for the second dielectric component mention may be made of polymeric materials, in particular polymeric materials having a refractive index n₂ greater by at least 0.001 units than the refractive index n₁ of the first dielectric component.

Non limiting examples of suitable polymeric materials are for instance poly(methyl methacrylate) (n_{PMMA}=1.494), polycarbonate (n_{PC}=1.590), polystyrene (n_{PS}=1.597), poly(styrene-co-acrylonitrile) (n_{SAN}=1.572), poly(vinyl carbazole) (n_{PVK}=1.683), cellulose acetate (n_{CA}=1.477).

In an advantageous aspect of the first embodiment of the invention the second dielectric component is an organic material selected from the group consisting of poly(methyl methacrylate), polycarbonate, polystyrene, cellulose acetate and poly(vinyl carbazole).

The second dielectric component may also be inorganic. Non limiting examples of suitable inorganic materials are for instance silica (n_{SiO2}=1.458), titania (n_{TiO2}=2.460), hafnia (n_{HfO2}=1.888), silicon (n_{Si}=3.497) and germanium (n_{Ge}=4.545).

In a second aspect of the first embodiment of the invention the second dielectric component has a refractive index n₂ smaller than n₁. Refractive index n₂ is typically at least 0.001 units smaller than n₁, preferably at least 0.005 units smaller than n₁. Refractive index n₂ is not less than 1.

The second dielectric component of this second aspect of the first embodiment is typically air. The second dielectric component of this second aspect may alternatively be a highly porous material with low refractive index such as an aerogel or a porous polymer structure.

In a second embodiment of the photonic crystal of the invention the second component is a metal or a dielectric material as defined above containing a metal. Any metal may be suitably employed in the photonic crystal of this second embodiment provided it has a refractive index n₂ different from n₁.

The Photonic Crystal

The photonic crystal of the invention comprises at least the first dielectric component and the second component periodically arranged in a two- or three-dimensional structure. Preferably, the photonic crystal of the invention comprises at least the first dielectric component and the second dielectric component periodically arranged in a two- or three-dimensional structure.

There is no limitation on the type of periodic arrangement of the first and second component provided such an arrangement produces a crystal lattice characterised by the presence of at least one photonic stop-band in at least two directions.

In a first embodiment of the invention the photonic crystal is a two-dimensional photonic crystal, that is the periodic variation of the refractive index takes place along two directions; the refractive index is homogeneous along the third one.

A non limiting example of a suitable two-dimensional photonic crystal structure is provided by a square lattice of dielectric columns of near infinite length. For certain values of the column spacing the crystal may have a photonic band gap in the xy plane; inside this gap incident light is reflected. The dielectric columns could be made of the first dielectric component, the second component, for instance air, filling the spaces between the columns.

Alternatively, the columns could be made of the second component, the first dielectric component comprising a fluoropolymer filling the spaces between the columns.

A further non limiting example of a two-dimensional photonic crystal is provided by one single layer of monodisperse spheres regularly arranged in a xy plane. Advantageously the spheres could be made of the second component, the first dielectric component filling the interstices defined by adjacent spheres.

In a second embodiment of the invention the photonic crystal is a three-dimensional photonic crystal, that is the periodic variation of the refractive index takes place along three directions.

The three-dimensional photonic crystal of the present invention may have a so-called opal structure, that is a structure wherein a plurality of monodisperse spheres is regularly arranged in a three-dimensional crystalline structure. The plurality of monodisperse spheres are close packed in the crystalline structure.

The crystalline structure typically has a hexagonal closed-packed or face centred cubic lattice, preferably a face centred cubic lattice.

The spectral region where the photonic crystal can be used is determined by the refractive index of the composing materials and by the diameter of the monodisperse spheres by known physical relationships. For instance, in order to obtain a photonic crystal whose stop-band(s) are located in the visible-near infrared region of the electromagnetic spectrum monodisperse spheres with a diameter of from 50 nm, preferably from 100 nm and up to 1000 nm, more typically of up to 800 nm can be used.

In the present invention advantageous results have been obtained with monodisperse spheres having a diameter of from 200 to 700 nm.

The term “monodisperse” is used herein to indicate that the average diameter of the spheres has a standard deviation that does not exceed 5%, preferably it does not exceed 3%.

The plurality of monodisperse spheres arranged in a three-dimensional crystalline structure defines a plurality of interstices, between the contiguous spheres in the three orthogonal directions. Generally said interstices are in continuous contact, forming a continuous matrix embedding the monodisperse spheres. The terms “interstices” and “matrix” will be used hereinafter to indicate the total volume of the plurality of interstices defined by the plurality of spheres in the photonic crystal.

The interstices in the three-dimensional crystalline structure are filled with a material having a refractive index different from the refractive index of the monodisperse spheres.

In a first, preferred, embodiment of the invention the photonic crystal comprises a plurality of monodisperse spheres made of the second dielectric component, preferably the second dielectric component, regularly arranged in a three-dimensional crystalline structure defining interstices, wherein the first dielectric component fills the interstices.

The second component, as defined above, may have a refractive index n₂ greater or smaller than the refractive index n₁ of the first dielectric component. Preferably, the second component is the second dielectric component.

In a first aspect of this embodiment the second dielectric component has a refractive index n₂ greater than the refractive index n₁ of the first dielectric component. The second dielectric component may be organic or inorganic.

Advantageously, the first dielectric component may comprise one fluoropolymer with a bulk refractive index n_{FP} comprised between 1.200 and 1.440, preferably between 1.250 and 1.400. The second dielectric component may then be conveniently selected from the group of organic polymeric materials consisting of poly(methyl methacrylate), cellulose acetate, polycarbonate, polystyrene and poly(vinyl carbazole). Suitable inorganic material for the second dielectric component may be selected from the group consisting of silica, germanium, titania and hafnia.

Preferably the first dielectric component is selected from the group consisting of the fluorinated polymers comprising alicyclic structures in the polymer main chain, the elastomers comprising fluoropolyether chains, the fluoroelastomers and the fluorosilicone rubbers

More preferably, the first dielectric component is selected from the group consisting of the fluorinated polymers comprising alicyclic structures in the polymer main chain and of elastomers comprising fluoropolyether chains as detailed above.

In an advantageous aspect of the invention the photonic crystal comprises a first dielectric component selected from the group consisting of the amorphous fluorinated polymers comprising recurring units derived from tetrafluoroethylene and the fluorodioxoles of formula (I) and of elastomers comprising fluoropolyether chains as detailed above; and a second dielectric component selected from the group consisting of poly(methyl methacrylate), polystyrene and silica.

More preferably the first dielectric component is an elastomer comprising fluoropolyether chains and the second dielectric component is selected from the group consisting of poly(methyl methacrylate), polystyrene and silica.

Advantageously, the photonic crystal of the invention comprises a plurality of monodisperse spheres made of poly(methyl methacrylate), polystyrene or silica regularly arranged in a three-dimensional crystalline structure defining interstices, wherein an elastomer comprising fluoropolyether chains as detailed above fills the interstices. The elastomer comprising fluoropolyether chains in the interstices conveniently has a refractive index n_{FP} of from 1.300 to 1.350.

A photonic crystal comprising a plurality of monodisperse spheres made of polystyrene having an average diameter of 300 nm regularly arranged in a three-dimensional crystalline structure and an elastomer comprising fluoropolyether chains having a refractive index n_{FP} of from 1.300 to 1.350, (commercially available under the trade name FLUOROLINK® PFPE MD500 from Solvay Specialty Polymers Italy SpA) in the interstices was found to have a photonic stop-band around 720 nm.

A photonic crystal comprising a plurality of monodisperse spheres made of polystyrene having an average diameter of 300 nm regularly arranged in a three-dimensional crystalline structure and an amorphous fluorinated polymer comprising recurring units derived from tetrafluoroethylene and a fluorodioxole of formula (I) as defined above wherein R₁═R₃═R₄═—F and R₂═—OCF₃ and having a refractive index n_{FP} of from 1.300 to 1.334, (commercially available under the trade name HYFLON® AD60 from Solvay Specialty Polymers Italy SpA) in the interstices was found to have a photonic stop-band around 690 nm.

When the second dielectric component has a refractive index n₂ smaller than the refractive index n₁ of the first dielectric component, the second dielectric component is typically air. In this embodiment the three-dimensional photonic crystal has a so-called “inverse opal” structure, that is the three-dimensional photonic crystal comprises a plurality of monodisperse spherical voids regularly arranged in a three-dimensional structure embedded in a matrix comprising the first dielectric component. The first dielectric component may be selected from the group consisting of the amorphous fluorinated polymers comprising alicyclic structures in the polymer main chain and of elastomers comprising fluoropolyether chains as defined above.

In an alternative embodiment of the invention the photonic crystal comprises a plurality of monodisperse spheres made of the first dielectric component regularly arranged in a three-dimensional crystalline structure defining interstices, wherein the second component fills the interstices. The definitions and preferences provided for the first embodiment of the photonic crystal equally apply to this alternative embodiment.

The two- or three-dimensional photonic crystal of the invention may be prepared by arranging the first dielectric component and the second component in a two- or three-dimensional periodic structure to obtain a photonic stop-band.

The two- or three-dimensional photonic crystal of the invention may be conveniently prepared according to a method comprising the steps of:
arranging the first dielectric component or the second component or a precursor thereof in a periodic two- or three-dimensional structure defining interstices; and
infiltrating the two- or three-dimensional periodic structure with the second component or the first dielectric component or a precursor thereof to fill the interstices;
wherein when the two- or three-dimensional periodic structure is made of the first dielectric component the interstices are filled with the second component and vice versa.

In an embodiment of the invention there is provided a method for the preparation of a two- or three-dimensional photonic crystal comprising the steps of:
providing a plurality of monodisperse spheres made of the first dielectric component or the second component regularly arranged in a two- or three-dimensional crystalline structure, said plurality of monodisperse spheres defining interstices;
infiltrating the crystalline structure with the second component or the first dielectric component or a precursor thereof to fill the interstices between said monodisperse spheres; wherein when the monodisperse spheres are made of the first dielectric component the interstices are filled with the second component and vice versa.

In a preferred aspect of this embodiment the method is used for the preparation of three-dimensional photonic crystals.

Methods known in the art may be employed for the preparation of the three-dimensional crystalline structure comprising the monodisperse spheres. Non-limiting examples of suitable methods are for instance sedimentation, wherein a colloidal suspension of the monodisperse spheres is allowed to settle, spin-coating, vertical deposition, or the Langmuir-Blodgett method for thin film preparation.

In a particularly advantageous method the monodisperse spheres are placed in a colloidal suspension with a suitable solvent and used to coat a substrate. The coating method uses the capillary force at the meniscus of the liquid to create ordered layers of monodisperse spheres on the substrate. Convection of the colloidal suspension by heating is employed to avoid the sedimentation of the monodisperse spheres. In this method, the substrate is slowly removed from the colloidal suspension while the suspension is heated. As the substrate is drawn through the meniscus of the colloidal suspension, the monodisperse spheres are deposited on the substrate in a highly ordered three-dimensional crystal structure.

The substrate is typically selected among materials having suitable optical properties.

Once the ordered three-dimensional crystal structure is created, infiltration of the other dielectric component in the interstices generated by the monodisperse spheres can be carried out using conventional methods, such as percolation or coating (dip-coating, spin-coating) of a liquid composition comprising the dielectric component or a precursor thereof.

At the end of the infiltration step additional steps may be carried out, such as drying or additional finishing steps, like polishing.

The use of amorphous polymers as dielectric components infiltrated in the interstices of the three-dimensional crystal structure provides the advantage that generally solutions of these polymers in suitable solvents can be obtained.

From this point of view, the use of amorphous fluorinated polymers comprising alicyclic structures in the polymer main chain or of fluoroelastomers as a first dielectric component filling the interstices between the monodisperse spheres is advantageous as these polymers are readily soluble in fluorinated or polar aprotic solvents providing solutions having low viscosity.

The use of elastomers comprising fluoropolyether chains or of fluorosilicone rubbers as a first dielectric component in the preparation of photonic crystals wherein the fluorinated polymer fills the interstices between monodisperse spheres is particularly advantageous from a manufacturing point of view. In fact in the preparation of this type of photonic crystals the step of infiltrating the three-dimensional structure of the monodisperse spheres can be carried out using a precursor composition of the elastomer or rubber. Advantageously a precursor composition comprising at least one functional fluoropolyether compound comprising a fluoropolyoxyalkylene chain and at least two unsaturated moieties and at least one photoinitiator, as defined above, can be used. These compositions are generally liquid at room temperature and provided with low viscosity thus facilitating the infiltration of the composition in the interstices of the crystal structure. Additionally, they do not contain any solvent, thus the removal of such a solvent by drying is not required. Once infiltration of the three-dimensional crystal structure is completed curing of the composition by means of UV radiation can be easily obtained, thus leading to the formation of the elastomer in the crystal structure.

Thus, in a specific aspect of the invention the method comprises the steps of:
providing a plurality of monodisperse spheres made of the second component regularly arranged in a two- or three-dimensional crystalline structure, said plurality of monodisperse spheres defining interstices;
infiltrating the crystalline structure with a precursor of the first dielectric component to fill the interstices between said monodisperse spheres, said precursor comprising at least one functional fluoropolyether compound comprising a fluoropolyoxyalkylene chain and at least two unsaturated moieties, and at least one photoinitiator; and
curing the precursor by UV radiation to obtain an elastomer comprising fluoropolyether chains filling the interstices.

The functional fluoropolyether compound is selected among the compounds of formula (IV) as defined above.

Photonic crystals having an “inverse opal” structure, that is comprising a plurality of monodisperse spherical voids in a matrix comprising a fluorinated polymer, can be prepared from corresponding photonic crystals obtained according to the method described above by removing the monodisperse spheres. Thus, the invention further comprises a method for the preparation of two- or three-dimensional photonic crystals, preferably three-dimensional photonic crystals which comprises the steps of:
providing a plurality of monodisperse spheres made of the second dielectric regularly arranged in a two- or three-dimensional crystalline structure, said plurality of monodisperse spheres defining interstices;
infiltrating the crystalline structure with the first dielectric component or a precursor thereof to fill the interstices between said monodisperse spheres; and
removing the plurality of monodisperse spheres.

It is to be understood that the material used for the preparation of the monodisperse spheres used as a template for the preparation of the “inverse opal” photonic crystal does not necessarily need to have a refractive index different from the refractive index of the first dielectric component comprising the fluorinated polymer. Rather the material will be selected to render the removal of the spheres from the crystal as convenient as possible.

Monodisperse spheres made of silica are typically used as they can be conveniently removed by etching using HF solutions. Alternatively, monodisperse spheres made of polymeric materials may be used. They can be removed by dissolution in a suitable solvent.

The photonic crystals of the invention may be suitably used in a variety of devices. Mention may be made of optical filters, waveguides, lasers, solar cells, sensor and biosensor devices, and chromatic stimuli-responsive devices.

It is understood that all preferences defined for the first dielectric component and the second component equally apply to the photonic crystal of the invention and to its method of manufacture as well as to the devices comprising the photonic crystal of the invention.

The invention will be now described in more detail with reference to the following examples, whose purpose is merely illustrative and not intended to limit the scope of the invention.

Should the disclosure of any patents, patent applications, and publications which are incorporated herein by reference conflict with the description of the present application to the extent that it may render a term unclear, the present description shall take precedence.

### EXAMPLES

General Procedure for the Preparation of Three-Dimensional Crystalline Structures Comprising Monodisperse Spheres

Polystyrene monodisperse spheres (n_{PS}=1.597) having a diameter of 260 nm, 300 nm, 340 nm, 426 nm or 520 nm (commercially available from Thermo Scientific) or silica monodisperse spheres having a diameter of 290 nm or 340 nm (prepared according to the procedure disclosed in STOBER, A., et al. Controlled Growth of Monodisperse Silica Spheres in the Micron Size Range. Journal of Colloid and Interface Science. 1968, vol. 26, p. 62-69. were suspended in deionized water. The suspensions (concentration: 0.3-50 mg/ml) were employed to grow three-dimensional ordered structures by using the vertical deposition technique. Growth occurred on glass substrates at 45°+/−1° inside a BF53 Binder incubator. The crystalline structures were composed of flat domains with the [111] direction of the face-centred cubic lattice of monodisperse spheres perpendicular to the substrate.

### Example 1

### Three-Dimensional Photonic Crystal Comprising an Elastomer Comprising Fluoropolyether Chains as First Dielectric Component and Polystyrene as the Second Dielectric Component

The interstices in a three-dimensional crystalline structure comprising polystyrene monodisperse spheres prepared according to the General Procedure described above were infiltrated by dip-coating using a liquid composition comprising commercially available under the trade name FLUOROLINK® MD500 (Solvay Specialty Polymers Italy SpA) containing a functional fluoropolyether compound of formula (IV)(ii) and a photoinitiator. Curing of the fluoropolyether compound was performed by UV irradiation of the crystal at a wavelength having the maximum centred at 254 nm for 2 minutes under a nitrogen flow to provide a cured elastomer comprising fluoropolyehter chains having a refractive index n_{FP}=1.312.

Transmittance (T) and reflectance (R) spectra were recorded with an Avaspec-2048 compact spectrometer (Avantes, 230-1100 nm spectral range, ca 1.4 nm spectral resolution). Light from a combined deuterium/tungsten-halogen lamp was guided by an optical fiber to proper collimating optics and linearly polarized using a Glenn-Thompson polarizer (Halbo Optics). The spot on the sample, which is mounted on a rotating goniometer, has a variable diameter in the range 0.5-5 mm. Transmitted light was collected and driven by another optical fiber to the spectrometer. Normal incidence reflectance was measured at six different spots (2 mm in diameter) by a Y reflection probe bundle fiber.

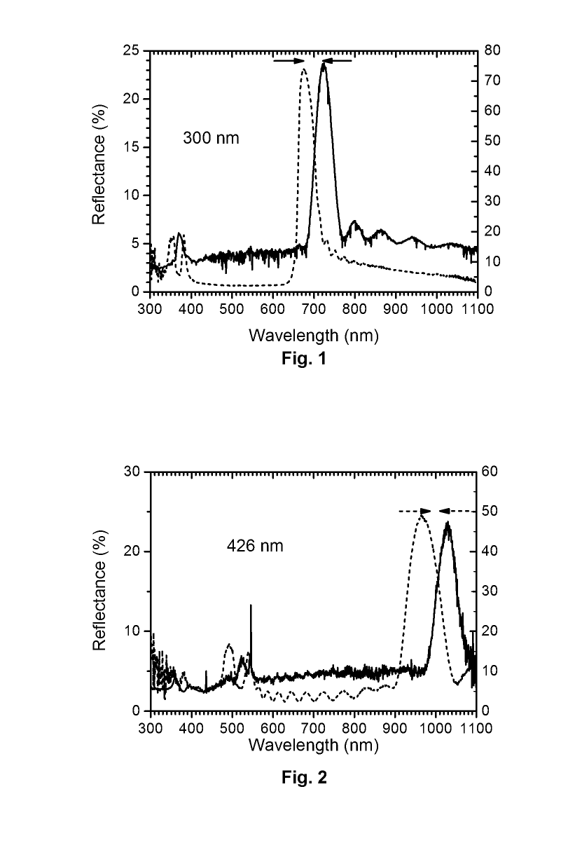

FIGS. 1 and 2 show the reflectance spectra obtained for 300 and 426 nm polystyrene opals infiltrated with Fluorolink® MD500 PFPE. For 300 nm opals, the stop band is shifted from 675 to 723 nm upon infiltration. For the 426 nm opal the same effect was observed with a shift of the stop band from 967 to 1032 nm. A reduction of the bandwidth as well as a reduction of the reflectance intensity was observed. Similar results were obtained also for 340 and 520 nm polystyrene microsphere diameters, thus unambiguously demonstrating that the infiltration process occurs independently on the microsphere diameter used.

Finally, it was noted that additional optical modes were observed at higher photon energies, namely below 400 and around 500 nm for 300 and 426 nm microsphere, respectively. These modes (also called van-Hove-like singularities), strongly related to the quality of the opal structure, appear to be shifted upon infiltration, thus demonstrating that the infiltration process does not affect the order of the opal structure. Similar results were obtained with silica-based opals, thus demonstrating that the infiltration process occurs also in inorganic-based photonic crystals.

The crystal obtained using polystyrene monodisperse spheres having a diameter of 300 nm showed a shift in the stop-band after infiltration from 675 nm to 723 nm, confirming the fact that the fluorinated polymer has filled the interstices generated by the monodisperse spheres. SEM (Scanning Electron Microscopy) images of this photonic crystal demonstrated that infiltration occurred with high quality.

Similarly, the stop-band of a three-dimensional crystal comprising polystyrene monodisperse spheres having a diameter of 426 nm shifted from 967 nm to 1032 nm.

### Example 2

### Three-Dimensional Photonic Crystal Comprising a tetrafluoroethylene/2,2,4-trifluoro-5-trifluoromethoxy-1,3-dioxole copolymer as First Dielectric Component and Polystyrene as the Second Dielectric Component

The interstices in a three-dimensional crystalline structure comprising polystyrene monodisperse spheres (diameter of 300 nm) prepared according to the General Procedure described above were infiltrated by dip coating using a 10 wt % solution of a tetrafluoroethylene/2,2,4-trifluoro-5-trifluoromethoxy-1,3-dioxole copolymer (commercially available as HYFLON® AD60 from Solvay Specialty Polymers Italy SpA) (n_{FP}=1.313) in a perfluopolyether solvent (Galden® PFPE HT110 from Solvay Specialty Polymers Italy SpA).

The solvent was removed by evaporation at room temperature.

The crystal obtained showed a shift in the stop-band after infiltration from 674 nm to 712 nm, confirming that the fluorinated polymer has filled the interstices generated by the monodisperse spheres.

### Example 3

### Three-Dimensional Photonic Crystal Comprising an Elastomer Comprising Fluoropolyether Chains as First Dielectric Component and Air as the Second Dielectric Component

A three-dimensional photonic crystal prepared according to Example 1 was treated with toluene to dissolve the polystyrene spheres providing a photonic crystal having an “inverse-opal” structure.

1. A two- or three-dimensional photonic crystal comprising at least a first dielectric component comprising at least one fluorinated polymer said first dielectric component having a refractive index n₁; and at least a second component having a refractive index n₂ different from n₁, wherein:
the first dielectric component is selected from the group consisting of fluorinated polymers comprising alicyclic structures in the polymer main chain and elastomers comprising fluoropolyether chains, and wherein the crystal comprises:
either a plurality of monodisperse spheres made of the second component regularly arranged in a two- or three-dimensional crystalline structure defining interstices wherein the first dielectric component fills the interstices,
or
plurality of monodisperse spheres made of the first dielectric component regularly arranged in a two- or three-dimensional crystalline structure defining interstices wherein the second component fills the interstices.

2. The photonic crystal according to claim 1, wherein the second component has a refractive index n₂ greater than n₁.

3. The photonic crystal according to claim 1, wherein the second component is a dielectric material selected from the group consisting of:
polymeric materials selected from the group consisting of poly(methyl methacrylate), polycarbonate, polystyrene, cellulose acetate and poly(vinyl carbazole) and
inorganic materials selected from the group consisting of silica, titania, hafnia, silicon and germanium.

4. The photonic crystal according to of claim 1, wherein the second component has a refractive index n₂ smaller than n₁.

5. The photonic crystal according to claim 4, wherein the second component is air.

6. The photonic crystal according to claim 1, wherein the second component is a metal or a dielectric material selected from the group consisting of:
polymeric materials selected from the group consisting of poly(methyl methacrylate), polycarbonate, polystyrene, cellulose acetate and poly(vinyl carbazole) and inorganic materials selected from the group consisting of silica, titania, hafnia, silicon and germanium, wherein the dielectric material comprises a metal.

7. The photonic crystal according to claim 1, wherein the fluorinated polymer has a bulk refractive index n_{FP} in the range from 1.250 to 1.350.

8. The photonic crystal according to claim 1, wherein the fluorinated polymers comprising alicyclic structures in the polymer main chain are selected from polymers comprising recurring units derived from at least one fluorinated monomer selected from the group consisting of:
fluorodioxoles of formula (I): 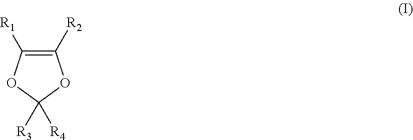
wherein R₁, R₂, R₃ and R₄, equal to or different from each other, are independently selected from the group consisting of —F, a C₁-C₆ fluoroalkyl, optionally comprising one or more oxygen atoms, and a C₁-C₆ fluoroalkoxy, optionally comprising one or more oxygen atoms;
fluorodioxolanes of formula (II): 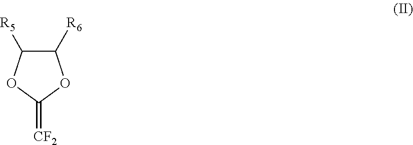
wherein R₅ and R₆, equal to or different from each other, are independently selected from the group consisting of —F, a C₁-C₆ fluoroalkyl, optionally comprising one or more oxygen atoms, and a C₁-C₆ fluoroalkoxy, optionally comprising one or more oxygen atoms; and
cyclopolymerizable monomers of formula (III):
CR₇R₈═CR₉OCR₁₀R₁₁(CR₁₂R₁₃)ₐ(O)_{b}CR₁₄═CR₁₅R₁₆ (III)
wherein each R₇ to R₁₆, independently of one another, is selected from —F, and a C₁-C₃ fluoroalkyl, a is 0 or 1, b is 0 or 1 with the proviso that b is 0 when a is 1.

9. The photonic crystal according to claim 8, wherein the fluorinated polymers are copolymers of tetrafluoroethylene and the fluorodioxoles of formula (I) wherein R₁═R₃═R₄═—F and R₂═—OCF₃ or wherein R₁═R₂═—F and R₃═R₄═—CF₃.

10. The photonic crystal according to claim 1, wherein the elastomers comprising fluoropolyether chains are those obtained by the UV-curing of compositions comprising: at least one functional fluoropolyether compound comprising a fluoropolyoxyalkylene chain (R_{f}) and having at least two unsaturated moieties; and at least one photoinitiator.

11. The photonic crystal according to claim 10, wherein the functional fluoropolyether compound is selected from the group consisting of compounds of formula (IV):
T₁-J-R_{f}-J′—T₂ (IV)
wherein
R_{f} represents a fluoropolyoxyalkylene chain comprising recurring units having general formula: —(CF₂)ₖ—CFZ—O—, wherein k is an integer of from 0 to 3 and Z is selected from a fluorine atom and a C₁-C₅ perfluoroalkyl group, optionally comprising one or more oxygen atoms;
J and J′, equal to or different from each other, are independently a bond or a divalent bridging group, and
T₁ and T₂, equal to or different from each other, are selected from the group consisting of:
(A) —O—CO—CR_{H}═CH₂,
(B) —O—CO—NH—CO—CR_{H}═CH₂, and
(C) —O—Co—R^{A}—CR_{H}═CH₂,
wherein R_{H} is H or a C₁-C₆ alkyl group; R^{A} is selected from the group consisting of:
(j) —NH—R^{B}—O—CO—, and
(jj) —NH—R^{B}—NHCOO—R^{B}—OCO—;
R^{B} being a divalent group selected from the group consisting of C₁-C₁₀ aliphatic group, C₅-C₁₄ cycloaliphatic group; C₆-C₁₄ aromatic and alkylaromatic group.

12. A method for preparing a two- or three-dimensional photonic crystal according to claim 1, the method comprising: infiltrating a crystalline structure comprising a plurality of monodisperse spheres made of the first dielectric component or the second component regularly arranged in a two- or three-dimensional crystalline structure, said plurality of monodisperse spheres defining interstices, with the second component or the first dielectric component or a precursor thereof, to fill the interstices between said monodisperse spheres such that a photonic stop-band is formed; wherein when the monodisperse spheres are made of the first dielectric component the interstices are filled with the second component and vice versa.

13. The method of claim 12, wherein the monodisperse spheres are made of the second component, and wherein the method further comprises removing the plurality of monodisperse spheres.

14. The method of claim 12 wherein the two- or three-dimensional periodic or crystalline structure is infiltrated with a precursor of the first dielectric component, said precursor comprising at least one functional fluoropolyether compound comprising a fluoropolyoxyalkylene chain and at least two unsaturated moieties and at least one photoinitiator; said method further comprising: curing the precursor by UV radiation to obtain an elastomer comprising fluoropolyether chains filling the interstices between the monodisperse spheres.

15. A device comprising the two- or three-dimensional photonic crystal of claim 1.
